(19) United States
(12) Patent Application Publication
(10) Pub. No.: US 2004/0025083 A1
(43) Pub. Date: Feb. 5, 2004

(54) Generating test code for software

(76) Inventors: Murthi Nanja, Portland, OR (US); Joel I. Marcey, Folsom, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/209,037

(22) Filed: Jul. 31, 2002

(51) Int. Cl. H02H 3/05; G06F 15/00; G06F 9/44

(52) U.S. Cl. 714/35; 712/227; 717/124

(57) ABSTRACT

Test cases are embedded in one or more routines in the code for a software program. Each test case may be designated with a keyword-like descriptor, and includes input and expected output values. A test code discovery and generation module generates test code for each test case, which then may be compiled and executed by a processor.

### BACKGROUND

This invention relates to software testing and to generating and running test code in software programs for processor based systems.

Software programs may be tested to ensure and verify their proper and expected functionality. In general, unit level testing or unit testing refers to testing part of a software program, i.e., a routine in a software program. Unit level testing involves preparing and applying test data which may include one or more test cases as input to a routine in the implementation code, and determining if the output generated for each test case is in accordance with functional requirements or other specifications. If problems are found during software testing, the problems may be corrected by, for example, debugging tools and techniques or editing and re-compiling the implementation code files.

Software programs may include one or more routines that are revised during initial development or thereafter. Once a routine is revised, the test code also may need to be revised so as to be consistent with the implementation code in the routine. However, the test code may be written or updated by someone other than the developer or programmer of the implementation code, or at a different time and place than the implementation code. There may be separate code bases for the test code and for the implementation code, and different code modules. For these reasons, it can be a difficult, burdensome and expensive to repeatedly or continually revise test code, especially if there is a significant degree of separation between implementation code and test code for that implementation.

### BRIEF DESCRIPTION OF THE DRAWINGS

FIG. 1 is a schematic diagram of test cases embedded in the software code according to one embodiment of the invention.

FIG. 2 is a flow diagram of an embodiment of the invention for embedding test cases in software code.

FIG. 3 is s flow diagram of an embodiment of the invention for generating and executing test code for the test cases embedded in the software code.

FIG. 4 is a block diagram of an embodiment of a processor based system for testing software programs according to one embodiment of the invention.

### DETAILED DESCRIPTION

In one embodiment of the invention, test cases are embedded in the code of a software program stored in memory or other machine readable storage medium. The test cases are used to generate test code to verify functionality of the implementation code. In one embodiment, test cases may be statically created in a software program during design time, and the test cases discovered, and test code generated and run dynamically at run time.

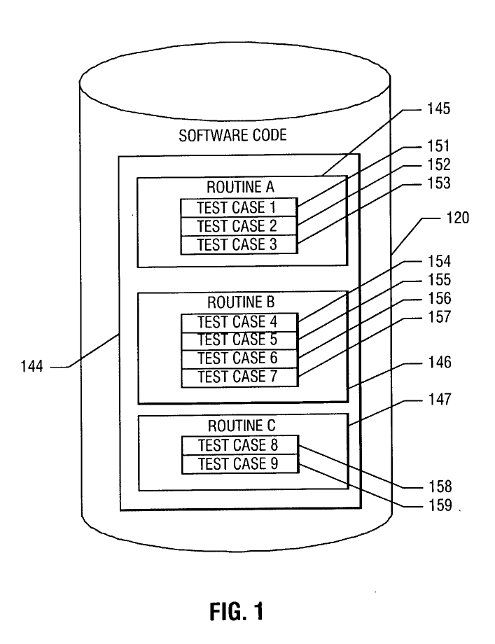

First referring to FIG. 1, code 144 for a software program is shown in storage device 120. As shown in FIG. 1, code 144 has routines A, B and C which include implementation code. These routines have reference numbers 145, 146 and 147. One or more test cases may be embedded within the software code for the routines.

For example, as shown in FIG. 1, test cases 1, 2 and 3 are embedded within the software code for routine A. The three test cases embedded in routine A have reference numbers 151, 152 and 153. Similarly, test cases 4, 5, 6 and 7 are shown as embedded in the software code for routine B. The four test cases embedded in routine B have reference numbers 154, 155, 156 and 157. Test cases 8 and 9, which are embedded in the software code for routine C, have reference numbers 158 and 159.

Test cases may be embedded in the software code during development of the implementation code or at any time thereafter. The test cases are embedded as functional lines of software code, and specify input as well as expected output values for one or more variables in the routine or function. The code in which the test cases are embedded may be source code written in a high level language such as C++ or C#. The code in which the test cases are embedded also may be the intermediate language code.

In one embodiment, each test case that is embedded in the software code includes: (a) a keyword-like descriptive declaration or title; (b) one or more values for input variables or parameters to the routine; (c) a value for the output value to expect upon return; and (d) the method to call, if any, depending on the return value's type. Any variable type may be used for the input and output or return values. For example, the input and output or return values may be strings of values.

In one embodiment of the invention, the keyword-like descriptive declaration identifying each test case is a “custom attribute” which is a designation available in the Common Language Infrastructure (CLI). A CLI feature called “reflection” may be used to obtain a test case identified with an attribute.

The CLI is a standard that allows software applications to be written in a variety of high level programming languages and executed in different system environments. Programming languages that conform to the CLI have access to the same base class library and are capable of being compiled into the same intermediate language (IL) and metadata. IL may then be further compiled into native code particular to a specific architecture. Because of this intermediate step, applications do not have to be rewritten from scratch. Their IL only needs to be further compiled into a system's native code.

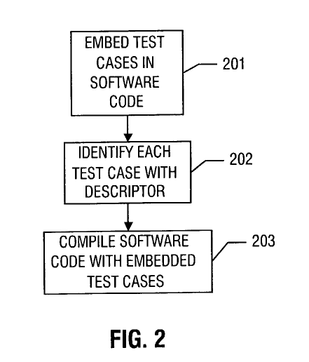

FIG. 2 is a flow diagram showing the embedding of test cases in the software code according to one embodiment of the invention. One or more of the items shown in blocks 201-203 may be carried out during software design or development, or at a later time if a software routine is updated or if additional test cases are to be included.

In block 201, one or more test cases are embedded in the software code of a routine in a software program. In block 202, each test case is identified by a keyword-like descriptor. If the software is developed in the CLI, for example, the descriptor called “custom attribute” may be used. In block 203, the software code with the embedded unit test cases may be compiled to generate an assembly file. Each unit test case embedded in the implementation code is included in the assembly file as metadata. In the CLI terminology, for example, this is called a personal executable (PE) file. The implementation code may be included in the assembly file as Intermediate Language (IL) code.

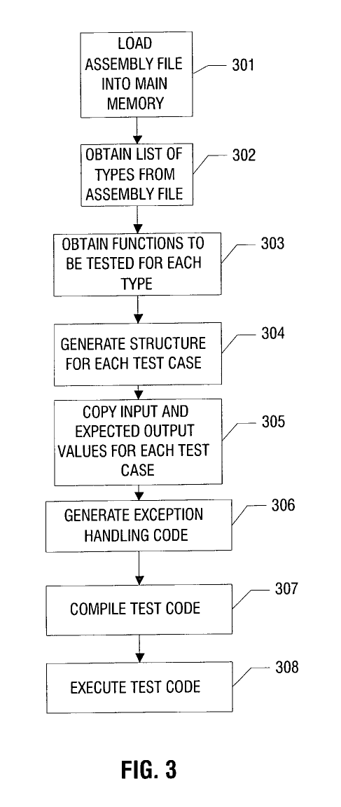

FIG. 3 is a flow diagram showing the generation and execution of test code for one or more test cases that were embedded in the software code. One or more of the items described in blocks 301-308 may be carried out during run time of the tests for the software program. In block 301, the assembly file including the compiled test cases is loaded into main memory. In block 302, a list of types having test cases is obtained from the assembly file. In one embodiment of the invention, the CLI reflection feature is used to obtain a list of these types from the assembly file.

In block 303, the methods (i.e., functions to be tested in each of the types) are obtained from the assembly file. In block 304, the test code structure is generated for each test case. In one embodiment, the test code structure includes calling up a function to be tested, specifying input and output to the function, and monitoring the function for exceptions.

One example of a suitable test code structure for use with the present invention is a “try and catch” block which is a program construct available in C#, C++ or other similar languages, that specifies a function to be tested, the values of variables as input and output to that function, and what to do with exceptions.

In block 305, values of the input and expected output for the test case are copied and inserted into the test code structure generated in block 304. In block 306, code for exception handling is generated.

In block 307, according to one embodiment of the invention, test code is compiled to create a test code executable file. For example, the test code may be compiled using a CLI extension called the Code Document Object Model (CodeDOM), which is available in the CLI.

The CodeDOM enables the output of source code in multiple programming languages at run time, based on a single model that represents the code to render. The CodeDOM provides classes, interfaces, and architecture that can be used to represent the structure of the source code, independent of a specific programming language. The CodeDOM provides the ability to output each representation as source code in a programming language that the CodeDOM supports, which can be selected at run time. To represent source code, CodeDOM elements are linked to each other to form a data structure known as a CodeDOM graph or CodeDOM tree, which models the structure of a source code document or segment.

In block 308, according to one embodiment, the test code may be executed. In this block, test results are generated which optionally may be sent to a file.

One embodiment of the present invention may be used for testing software applications written in C#, C++, or various other high level languages within the CLI. This embodiment of the invention allows applications written in a number of different languages to be tested without rewriting the software to take into consideration the unique characteristics of each language.

An advantage of implementing an embodiment of the present invention using the CLI structure is that no special compiler flags are required to process custom attributes. The custom attributes may be stored in the assembly file along with other metadata information (e.g., types, methods, properties, fields, etc.) that the compiler generates for the implementation code. The assembly file may be deployed on a local machine, intranet, internet, or other device or processor based system.

Other embodiments of the invention may be used to test software that is developed outside the CLI. For example, one embodiment of the present invention may be useful to test software developed in programming languages such as Java. One embodiment of the invention may use other structures similar to “try and catch” block to monitor return values for test cases. Thus, embodiments of the present invention may be implemented in languages other than C#, C++ or other languages in the CLI, to embed test cases in software code, generate and run test code for the test cases.

In one embodiment of the invention, the generation, compiling and execution of the test code may be integrated together so that a single command may be used to automatically and sequentially generate, compile, and execute the test code, without further intervention from a tester. This automatic, “one touch” feature reduces the burden and expense of running each test, particularly when tests may be repeated numerous times.

Embodiments of the invention may be implemented with so-called “black box” testing and/or “white box” (also known as “glass box”) testing. The term “black box” testing refers to software testing in which only the appropriate input and expected output data of the software are known, but the internal structure and design of the software are not known and/or are not considered during or in connection with the test. On the other hand, “white-box” testing refers to testing in which the internal structure and design of the software are known and/or are considered by the tester. In white box testing, the internal workings of the software are known, so input data may be applied or directed to test specified code, portions of the code, and/or specified functionality of the software.

Another advantage of certain embodiments of the invention is that they may be used for CLI compliance testing. For example, the invention may be used to check compliance of standardized CLI Application Program Interface (API) implementations against published CLI specifications. CLI compliance test cases may be prepared and embedded in library stub code. The class library stub code may be compiled to get a class library assembly with CLI compliance test cases represented as metadata. Test code then may be generated based on the CLI compliance test cases, and run to check compliance of the standardized API implementations against a specification

Other advantages of embodiments of the invention include reduced time for software developers and/or testers to write test code for software programs, and reduced or eliminated need for software test engineers and managers to run test code. This reduces the time and cost for test development and increases the productivity of the software development. Another advantage of embodiments of the invention is that they can automate the preparation, generation and execution of test cases, by accomplishing them with a single command.

In one embodiment of the invention, test cases embedded in the software code may be eliminated from the production release of the software. For example, the test cases may be eliminated from the software code by using a conditional compilation feature.

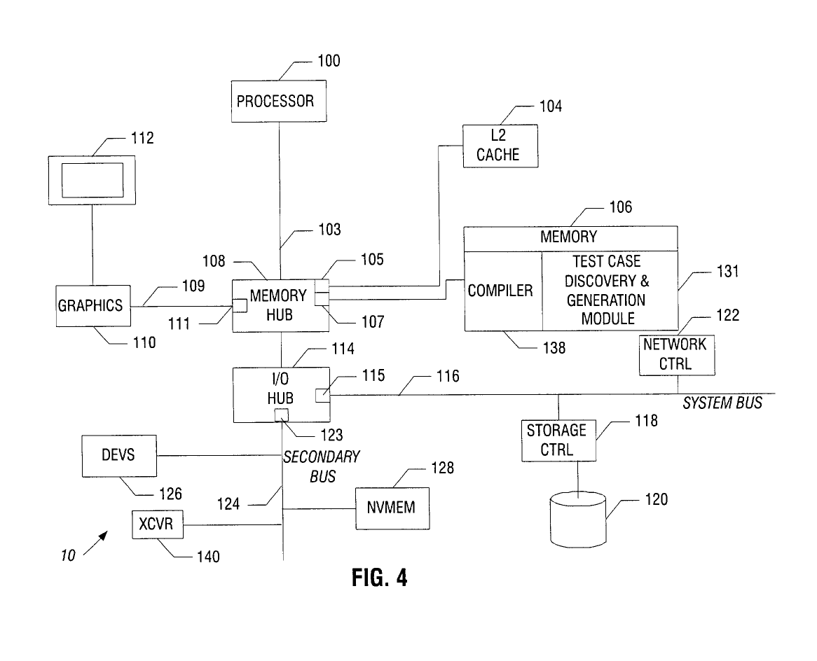

Now referring to FIG. 4, in one embodiment, a system 10 includes a processor 100, which may include a general-purpose or special-purpose processor such as a microprocessor, microcontroller, an application-specific integrated circuit (ASIC), a programmable gate array (PGA), and the like. The processor 100 may be coupled over a host bus 103 to a memory hub 108 in one embodiment, which may include a memory controller 107 coupled to a main memory 106. In addition, the memory hub 108 may include cache controller 105 coupled to an L2 cache 104. The memory hub 108 may also include a graphics interface 111 that is coupled over a link 109 to a graphics controller 110, which may be coupled to a display 112. As an example, the graphics interface 111 may conform to the Accelerated Graphics Port (A.G.P.) Interface Specification, Revision 2.0, dated in May 1998.

The memory hub 108 may also be coupled to an input/output (I/O) hub 114 that includes bridge controllers 115 and 123 coupled to a system bus 116 and a secondary bus 124, respectively. As an example, the system bus may be a Peripheral Component Interconnect (PCI) bus, as defined by the PCI Local Bus Specification, Production Version, Revision 2.1 dated in June 1995. The system bus 116 may be coupled to a storage controller 118 that controls access to one or more storage devices 120, including a hard disk drive, a compact disc (CD) drive, or a digital video disc (DVD) drive. Other storage media may also be included in the system.

In an alternative embodiment, the storage controller 118 may be integrated into the I/O hub 114, as may other control functions. The system bus 116 may also be coupled to other components including, for example, a network controller 122 that is coupled to a network port (not shown).

Additional devices 126 may be coupled to the secondary bus 124, such as an input/output control circuit coupled to a parallel port, serial port, and/or floppy disk drive. A non-volatile memory 128 may also be coupled to the secondary bus 124. Further, a transceiver 140, which may include a modem or a wireless communications chip, as examples, may also be coupled to the secondary bus.

Although the description makes reference to specific components of the system 10, it is contemplated that numerous modifications and variations of the described and illustrated embodiments may be possible. For example, instead of memory and I/O hubs, a host bridge controller and system bridge controller may provide equivalent functions, with the host bridge controller coupled between the processor 100 and system bus 116, and the system bridge controller 123 coupled between the system bus 116 and the secondary bus 124. In addition, any of a number of bus protocols may be implemented.

In one embodiment of the invention, test case discovery and generation module 131 generates test code based on the information specified in the test cases embedded in the software code. The test code generated by this module may be compiled by compiler 138 and executed by processor 100.

Test case discovery and generation module 131 may be embodied in software or firmware, or otherwise tangibly embodied in main memory 106 as shown in FIG. 4. Alternatively, the test case discovery and generation module may be stored in one or more storage devices.

Compiler 138 is a software or firmware program that may be used to transform the software code, including the test cases as well as the implementation code, into machine language. As shown in FIG. 4, the compiler also may be in main memory 106. Alternatively, the compiler may reside in a storage device.

Storage media suitable for tangibly embodying software and firmware instructions for the test case discovery and generation module may include different forms of memory including semiconductor memory devices such as dynamic or static random access memories, erasable and programmable read-only memories (EPROMs), electrically erasable and programmable read only memories (EEPROMs), and flash memories,; magnetic disks such as fixed, floppy and removable disks; other magnetic media including tape; and optical media such as CD or DVD disk. The instructions stored in the storage media when executed cause a processor based system to perform programmed acts.

The software or firmware can be loaded into the system in one of many different ways. For example, instructions or other code segments stored on storage media or transported through a network interface card, modem, or other interface mechanism may be loaded into the system and executed to perform programmed acts. In the loading or transport process, data signals that are embodied as carrier waves (transmitted over telephone lines, network lines, wireless links, cables and the like) may communicate the instructions or code segments to the system.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
embedding a test case in code of a software routine, the test case specifying at least one expected output value;
identifying the test case with a keyword-like descriptor.

2. The method of claim 1 further comprising generating test code from the embedded test case.

3. The method of claim 2 further comprising executing the test code generated for the embedded test case.

4. The method of claim 2 further comprising generating a try and catch block for the embedded test case.

5. The method of claim 1 further comprising embedding a plurality of test cases in code of a software routine.

6. The method of claim 1 further comprising identifying the test case with a custom attribute using the Common Language Infrastructure.

7. A system comprising:
a storage device storing code for a software program, the code having a test case embedded therein, the test case having at least one output value; and
a processor coupled to the storage device to generate and execute test code for the test case.

8. The system of claim 7 further comprising a compiler to compile the code for the software program including the embedded test case.

9. The system of claim 7 wherein the embedded test case is identified with a keyword-like descriptor.

10. The system of claim 7 wherein a plurality of test cases are embedded in the code for the software program.

11. The system of claim 7 wherein the routine generates a try and catch block in the test code for the test case.

12. The system of claim 7 wherein the storage device stores code for a plurality of software programs, and test cases are embedded in the code for a plurality of the software programs.

13. An article including a machine-readable storage medium containing instructions that if executed enables a system to:
obtain a test case embedded in code for a software program, the test case specifying at least one expected output value for the software program; and
generate test code for the software program including the expected output value specified in the test case.

14. The article of claim 13 wherein the system is enabled to obtain more than one test case for the software program.

15. The article of claim 13 wherein the system is enabled to generate a try and catch block for the test case.

16. The article of claim 13 wherein the system is enabled to compile test code for the test case.

17. The article of claim 13 wherein the system is enabled to execute test code for the test case.

18. The article of claim 13 wherein the system is enabled to compile and execute test code for the test case.

19. The article of claim 13 wherein the software program is compatible with the Common Language Infrastructure.

20. The article of claim 13 wherein the system is enabled to generate test code for multiple software programs.
